(19) United States
(12) Patent Application Publication
(10) Pub. No.: US 2026/0361989 A1
(43) Pub. Date: Nov. 12, 2026

(54) IMAGING CONTROL APPARATUS, IMAGING CONTROL METHOD, AND STORAGE MEDIUM

(71) Applicant: CANON KABUSHIKI KAISHA, Tokyo (JP)

(72) Inventor: NATSUHO MURATA, Kanagawa (JP)

(21) Appl. No.: 19/656,824

(22) Filed: Apr. 23, 2026

(30) Foreign Application Priority Data
May 8, 2025 (JP) 2025-077995

(51) Int. Cl. H04N 23/58; H04N 23/63; H04N 23/68

(52) U.S. Cl. CPC H04N 23/58; H04N 23/634; H04N 23/6812

(57) ABSTRACT

An imaging control apparatus controlling an imaging apparatus determines whether a position of an object present around a moving body is within an angle of view of the imaging apparatus and imaging priority of the object based on the position of the object. The imaging control apparatus, based on the determination results, controls an imaging direction or the angle of view of the imaging apparatus.

### BACKGROUND

### Field of the Technology

The present disclosure relates to an imaging apparatus, an imaging control method, and a storage medium.

### Description of the Related Art

In recent years, in a navigation system mounted on a moving body such as a vessel, an automobile, or an aircraft, pan, tilt, and zoom of an imaging apparatus are controlled based on information about various kinds of sensing data including a type of object, a direction, a speed, and a distance.

Japanese Patent Laid-Open No. 2019-064402 describes a method of issuing a warning based on a detection result of a floating body by a laser scanner mounted on a vessel, and changing an imaging direction of a camera to image the detected floating body. The technique described in Japanese Patent Laid-Open No. 2019-064402 enables a ship pilot to determine whether it is necessary to monitor an object (floating body) detected by the laser scanner by viewing an image of the object captured by the camera on a monitor in the ship’s wheelhouse.

In a case of the technique described in Japanese Patent Laid-Open No. 2019-064402, the pilot of the moving body, such as a vessel, is required to determine whether it is necessary to monitor an object by viewing the captured image on the monitor every time a peripheral object of the moving body is detected by the laser scanner and imaged by the camera, which may impair controllability of the moving body.

### SUMMARY

According to an aspect of the present disclosure, an imaging control apparatus controlling an imaging apparatus comprises at least one memory storing a program, and at least one processor, that when executing the program, causes the imaging control apparatus to determine whether a position of an object present around a moving body is within an angle of view of the imaging apparatus, determine imaging priority of the object based on the position of the object, and control at least one of an imaging direction of the imaging apparatus or the angle of view of the imaging apparatus based on the determined position of the object and the determined imaging priority.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram illustrating a configuration example of an imaging system according to a first embodiment. FIG. 1B is a block diagram illustrating an example of a hardware configuration of an imaging control apparatus according to the first embodiment.

FIG. 2 is a block diagram illustrating an internal configuration of the imaging control apparatus.

FIG. 3 is a flowchart of processing in the imaging control apparatus.

FIG. 4 is a diagram illustrating an in-angle-of-view determination method.

FIG. 5 is a diagram illustrating indices for determining imaging priority, and points of the imaging priority.

FIG. 6 is a diagram illustrating examples of an angle of view of an imaging apparatus and the points of the imaging priority.

FIG. 7 is a flowchart of processing in a case where an object having high imaging priority is absent.

FIG. 8 is a flowchart of processing in a case where one object having high imaging priority is present.

FIG. 9 is a flowchart of processing in a case where a plurality of objects having high imaging priority is present.

FIG. 10 is a diagram illustrating an example in which an imaging direction is changed to a direction of the object having high imaging priority.

FIG. 11 is a diagram illustrating an example in which a traveling direction and the object having high imaging priority are caused to fall within the same angle of view.

FIG. 12 is a diagram illustrating an example in which all objects having high imaging priority are caused to fall within the same angle of view.

FIG. 13 is a diagram illustrating an example in which all objects having high imaging priority are present outside the angle of view.

FIG. 14 is a diagram illustrating an example in which an object having the highest imaging priority is preferentially caused to fall within the angle of view.

FIG. 15 is a flowchart of display of object information and processing corresponding to a user instruction.

FIG. 16 is a diagram illustrating a display example of a peripheral object list in order of imaging priority.

### DESCRIPTION OF THE EMBODIMENTS

Embodiments according to the present disclosure are described below with reference to the drawings. The embodiments described below do not limit the present disclosure, and all combinations of features described in the embodiments are not necessarily essential for solutions of the present disclosure. Configurations in the embodiments can be appropriately corrected or changed depending on a specification of an apparatus to which the present disclosure is applied, and various kinds of conditions (e.g., use condition and use environment). In addition, parts of the embodiments described below may be appropriately combined. In the following embodiments, repetitive description about the same or similar components and processing steps is omitted.

### First Embodiment

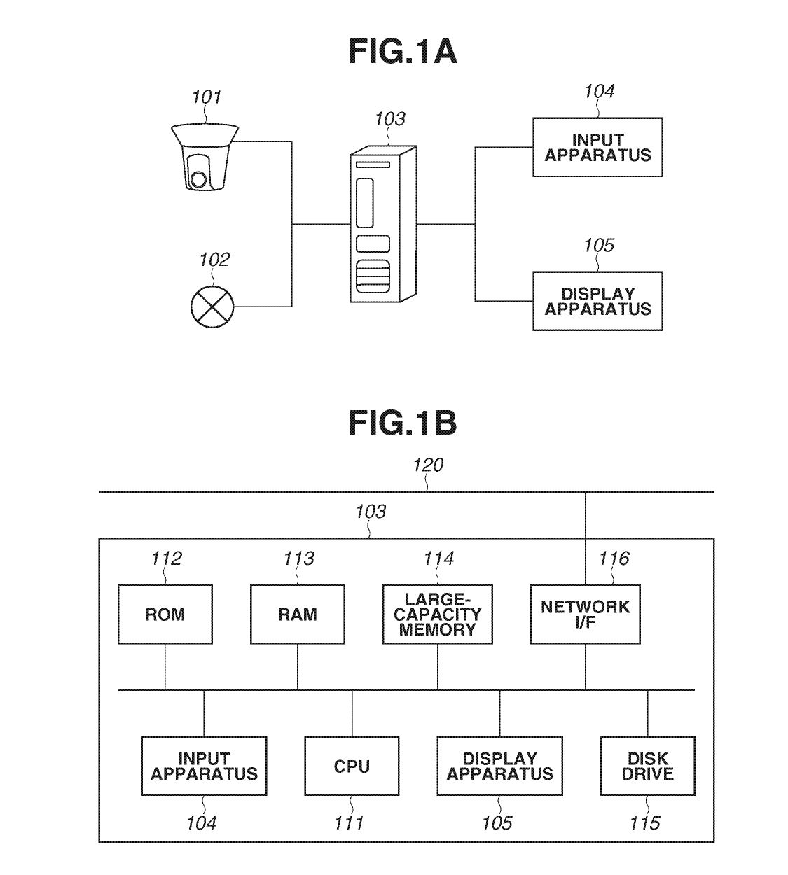

FIG. 1A is a diagram illustrating a configuration example of an imaging system according to a first embodiment.

The imaging system illustrated in FIG. 1A includes an imaging apparatus 101, a sensing device 102, an imaging control apparatus 103, an input apparatus 104, and a display apparatus 105. The imaging apparatus 101 captures a moving image or a still image, and performs image processing. The imaging apparatus 101, the sensing device 102, and the imaging control apparatus 103 are connected so as to be mutually communicable via an internet protocol (IP) network. The input apparatus 104 and the display apparatus 105 are connected to the imaging control apparatus 103. The input apparatus 104 and the display apparatus 105 may be included in the imaging control apparatus 103.

In the present embodiment, an example will be described in which the imaging system illustrated in FIG. 1A is installed in a moving body such as a vessel. A type, an installation place, and an imaging direction of the imaging apparatus 101, and the number of imaging apparatuses 101 are optional. In the present embodiment, the imaging apparatus 101 is assumed to be a visible camera in which an imaging direction and an imaging angle of view can be changed by pan/tilt/zoom driving. An example is assumed and described in which the imaging apparatus 101 is installed in the moving body such as a vessel, and is disposed at a place where the imaging apparatus 101 can image a traveling direction of the moving body.

FIG. 1B is a diagram illustrating an example of a hardware configuration of the imaging control apparatus 103 according to the present embodiment. FIG. 1B illustrates a configuration example in which the input apparatus 104 and the display apparatus 105 are included in the imaging control apparatus 103.

The imaging control apparatus 103 includes a central processing unit (CPU) 111, a read only memory (ROM) 112, a random access memory (RAM) 113, a large-capacity memory 114, a disk drive 115, and a network interface (I/F), and also includes the input apparatus 104 and the display apparatus 105. The network I/F 116 is connected to a network 120, and is assumed to be connected to the imaging apparatus 101 and the sensing device 102 illustrated in FIG. 1A via the network 120. Each connection between the imaging control apparatus 103 and the imaging apparatus 101 and between the imaging control apparatus 103 and the sensing device 102 is not limited to wired connection, and may be wireless connection.

The CPU 111 controls the imaging control apparatus 103. The ROM 112 stores control programs or the like for the CPU 111 to perform functions as the imaging control apparatus according to the present embodiment. In place of the ROM 112, a secondary storage device may also be provided. The RAM 113 is a memory for the CPU 111 to develop programs read out from the ROM 112 and to perform processing. The RAM 113 is also used as a temporary storage area for temporarily storing data that is a target for various kinds of processing.

The large-capacity memory 114 is a hard disk drive (HDD), a solid state drive (SSD), or the like, and can store an image captured by the imaging apparatus 101, and the like. The network I/F 116 is a circuit for performing communication via the network 120. The disk drive 115 includes a disk-shaped recording medium. The control programs according to the present embodiment may be recorded in the large-capacity memory 114 or the disk-shaped recording medium included in the disk drive 115, or may be acquired from an external apparatus or the like via the network 120.

The display apparatus 105 displays a captured image acquired by the imaging apparatus 101, a user interface (UI) screen, and the like.

The input apparatus 104 is an apparatus including at least one of the following: various kinds of buttons or keys for input, a pointing device, a mouse, or a touch panel for designating a display position of a display area on the display apparatus 105.

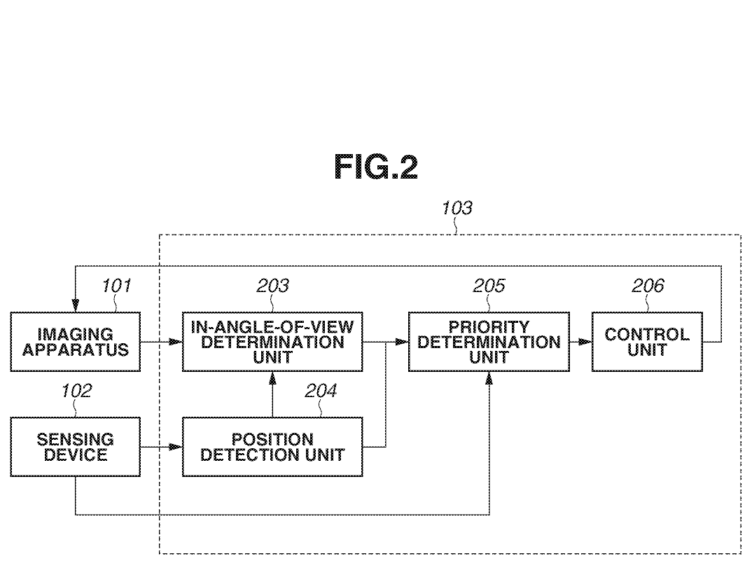

FIG. 2 is a block diagram illustrating the imaging apparatus 101, the sensing device 102, and an internal functional configuration example of the imaging control apparatus 103.

The imaging apparatus 101 includes an imaging optical system including one or more lenses, and a visible light imaging element that images an optical image formed by the imaging optical system and converts the optical image into an electric signal. The imaging apparatus 101 is installed in the moving body and disposed at a place where the imaging apparatus 101 can image a traveling direction of the moving body, and the imaging apparatus 101 images a peripheral state. The imaging apparatus 101 includes mechanisms for pan (P), tilt (T), and zoom (Z), and can adjust an imaging direction and an imaging angle of view. In the following, pan/tilt/zoom is referred to as PTZ. The imaging apparatus 101 is not limited to the visible light camera that can perform PTZ (pan/tilt/zoom), and may be, for example, a thermal camera that can perform PTZ or an omnidirectional camera that can perform simultaneous imaging over 360 degrees.

The sensing device 102 includes one or more of an acceleration sensor, a gyroscope, a radar, an automatic identification system (AIS), a sonar, a distance sensor (light detection and ranging (LiDAR)), and the like. The sensing device 102 performs sensing as needed, and outputs detection information on an object (hereinafter, referred to as object information) present around the moving body, to the imaging control apparatus 103. The object information detected by the sensing device 102 is information indicating, for example, a position, a type, a direction, a speed, a distance, a scheduled course, or a traveling direction of each object.

A position detection unit 204 acquires positional information on the object present around the moving body based on the object information detected by the sensing device 102.

An in-angle-of-view determination unit 203 determines whether a position of the object detected by the position detection unit 204 is within the imaging angle of view of the imaging apparatus 101 at the present moment.

A priority determination unit 205 determines imaging priority of the object present around the moving body based at least on the positional information on the object detected by the position detection unit 204. The imaging priority determination by the priority determination unit 205 is not limited to a case based only on the positional information on the object. The priority determination unit 205 may perform the imaging priority determination based on a distance from the moving body to the object, a speed of the object, a relative speed between the moving body and the object, a scheduled course of the moving body, a traveling direction of the object, a result of prediction using an artificial intelligence (AI) technique, and the like. Details of the imaging priority and processing for determining the imaging priority are described below.

A control unit 206 changes the imaging direction and the angle of view of the imaging apparatus 101. In other words, the control unit 206 changes an imaging range to be determined by the imaging direction and the angle of view based on a result of the imaging priority determination by the priority determination unit 205. In the present embodiment, an example is described in which only the imaging direction is changed, as an example in which the imaging range of the imaging apparatus 101 is changed. However, the imaging angle of view may be changed. The imaging direction and the imaging angle of view are changed by, for example, PTZ control performed on the imaging apparatus 101.

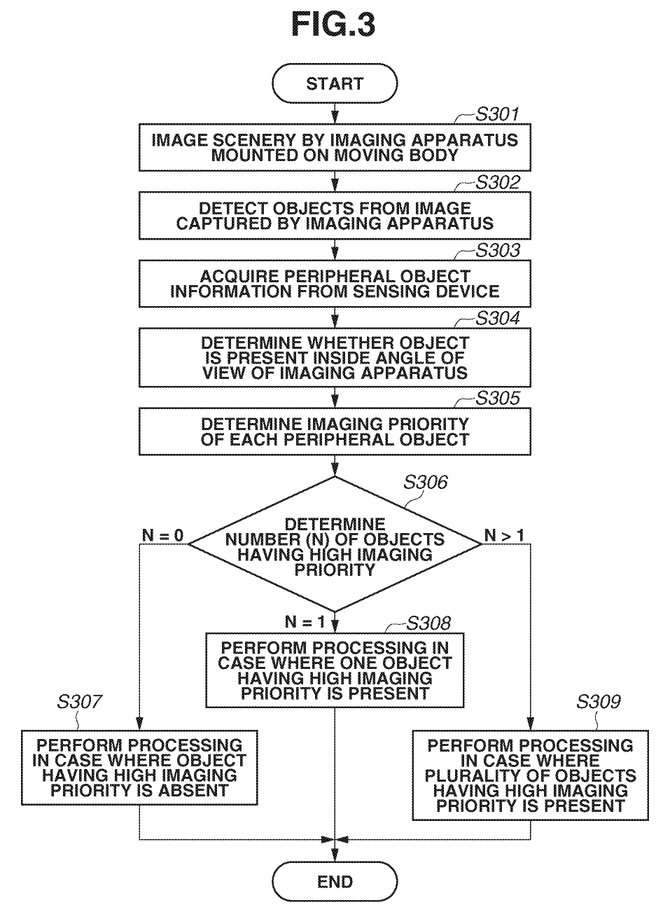

Operation of the imaging control apparatus 103 according to the present embodiment is described below with reference to FIGS. 3 to 9.

FIG. 3 is a flowchart illustrating a flow of control processing by the imaging control apparatus 103.

In step S301, the control unit 206 of the imaging control apparatus 103 controls the imaging apparatus 101 to image a scenery around the moving body.

In step S302, the in-angle-of-view determination unit 203 detects objects from a captured image acquired by the imaging apparatus 101. As a method of detecting the objects, various methods can be employed such as a pattern matching method, a method using luminance gradient in a local area, and a method based on machine learning such as deep learning.

In step S303, the position detection unit 204 acquires object information, which is a detection result of the objects present around the moving body detected by the sensing device 102. As described above, the object information is information on the position, the speed, the distance, the scheduled course, and the like of each object.

In step S304, the in-angle-of-view determination unit 203 performs in-angle-of-view determination processing based on the detection result of the objects from the captured image in step S302, PTZ setting information on the imaging apparatus 101, and the positional information on the objects acquired from the object information by the position detection unit 204.

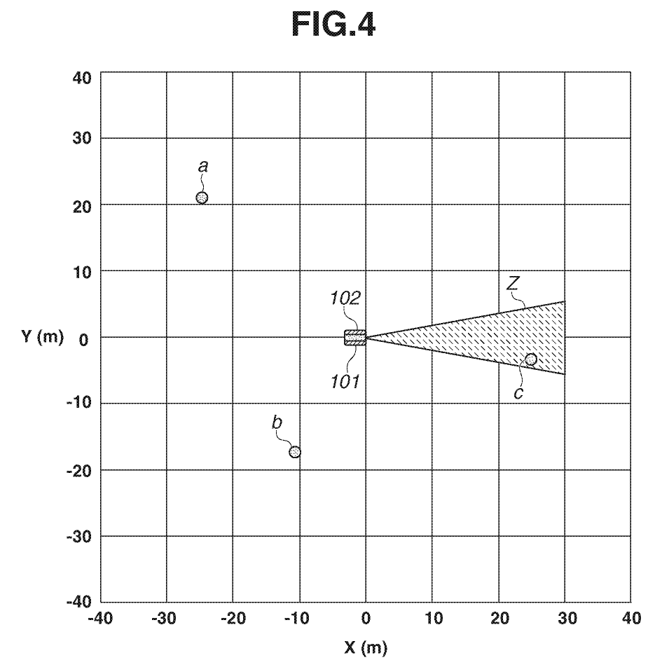

The in-angle-of-view determination processing is described with reference to FIG. 4. In an example illustrated in FIG. 4, a state is assumed where an object a, an object b, and an object c are present around the moving body mounted with the imaging apparatus 101 and the sensing device 102. In the present embodiment, it is assumed that the imaging apparatus 101 and the sensing device 102 are previously calibrated, and both data on the captured image and data on the object information are convertible to data in the same coordinate system.

The in-angle-of-view determination unit 203 acquires positional information on the objects a, b, and c that are acquired by the position detection unit 204 from object information on the objects a, b, and c detected by the sensing device 102. The in-angle-of-view determination unit 203 acquires the PTZ setting information on the imaging apparatus 101, and acquires an imaging angle of view Z in the imaging direction of the imaging apparatus 101 at the present moment from the PTZ setting information. The in-angle-of-view determination unit 203 then converts the positional information on each of the objects a, b, and c into data in the coordinate system of the imaging apparatus 101, and determines whether the objects detected by the sensing device 102 are present inside the imaging angle of view Z of the imaging apparatus 101 at the present moment. In a case of the example illustrated in FIG. 4, a result of the in-angle-of-view determination that the object c is present inside the imaging angle of view Z of the imaging apparatus 101, and the object a and the object b are present outside the angle of view is obtained.

Returning to FIG. 3, in step S305, after step S304 described above, the priority determination unit 205 determines imaging priority of each of the objects that have been detected by the sensing device 102 and the positions of which have been acquired by the position detection unit 204.

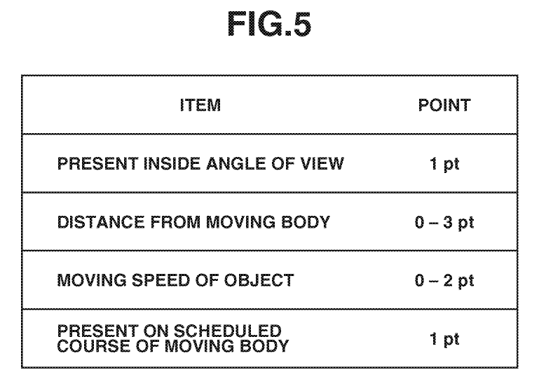

For example, the priority determination unit 205 gives points to each of the objects based on indices as illustrated in FIG. 5, and determines the imaging priority based on the points. More specifically, the priority determination unit 205 gives points for each of items representing indices such as the distance to the object, the speed of the object, the relative speed to the object, the scheduled course, and the traveling direction of the object, and calculates a total point of the items as the imaging priority. The imaging priority may be calculated using all the indices, or may be calculated based on points of at least one index.

The indices exemplified as the items illustrated in FIG. 5 are assumed such that the point becomes higher as the object detected by the sensing device 102 has a higher possibility of approaching the moving body.

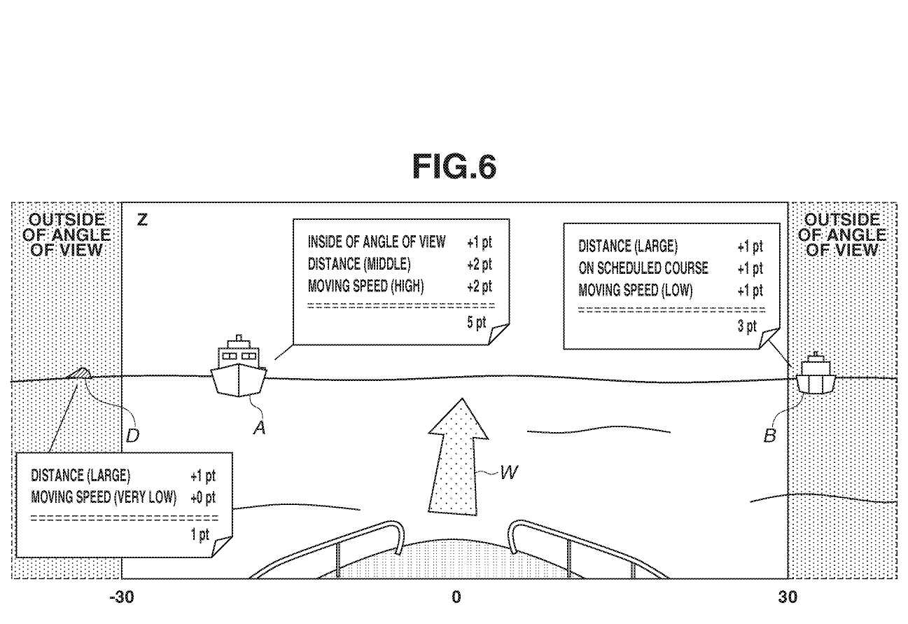

FIG. 6 is a diagram illustrating a relationship of a scheduled course W of the moving body (a vessel in this example), the imaging angle of view Z in the imaging direction of the imaging apparatus 101 mounted on the moving body at the present moment, another vessel A present inside the imaging angle of view Z, and a reef D and a vessel B present outside the imaging angle of view Z. In a case where the image captured by the imaging apparatus 101 is displayed on a monitor (e.g., display apparatus 105) in a pilothouse of the vessel as the moving body, the image captured at the imaging angle of view Z illustrated in FIG. 6 is displayed.

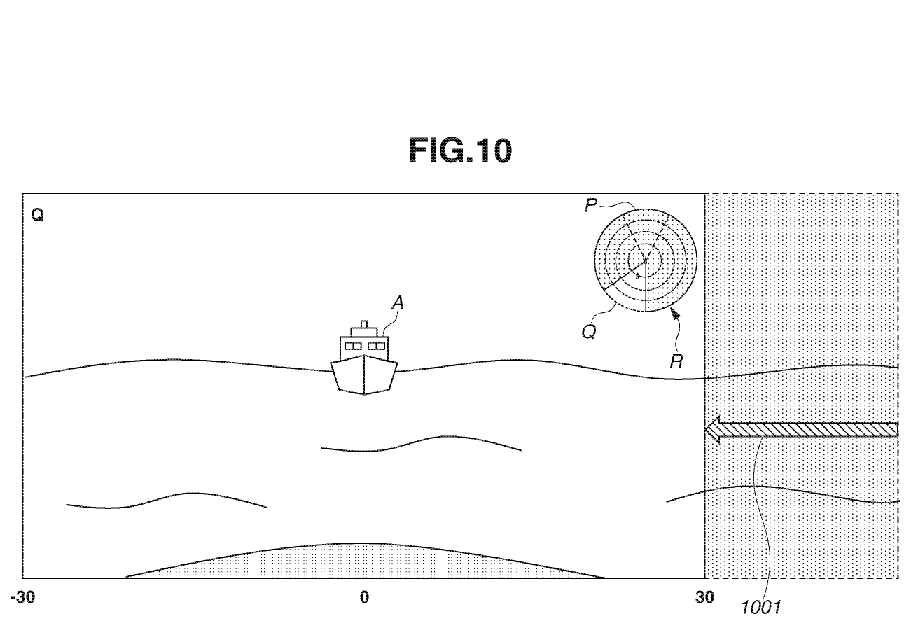

With respect to figures illustrated similarly to FIG. 6 (FIGS. 10 to 14, FIG. 16, etc.) in the following description, for example, in a case where the image is displayed on the display apparatus 105, the image captured by the imaging apparatus 101 is displayed in a manner similar to FIG. 6.

FIG. 6 also illustrates the indices used for the above-described calculation of imaging priority (inside of angle of view, distance, moving speed, on scheduled course, etc.), respective points corresponding thereto, and a total point for each of the vessel A, the vessel B, and the reef D. The indices and the points are drawn on the diagram for facilitating understanding of description, and are not information to be displayed on the monitor, but may be displayed on the monitor.

In the example illustrated in FIG. 6, for the vessel A, 1 point is given to an item of "inside of angle of view" because the vessel A is present inside the imaging angle of view Z, 2 points are given to an item of "distance" because a distance between the vessel A and the moving body is small, and 2 points are given to an item of "moving speed" because the moving speed of the vessel A is high. As described above, since the vessel A is present inside the imaging angle of view Z, the distance between the vessel A and the moving body is small, and the moving speed of the vessel A is high, it is determined that the vessel A has a high possibility of approaching the moving body, and the total point is determined to be a high value of 5 points.

For the vessel B, 1 point is given to the item of "distance" because a distance between the vessel B and the moving body is large, 1 point is given to an item of "on scheduled course" because the vessel B may be present on the scheduled course W, and 1 point is given to the item of "moving speed" because the moving speed of the vessel B is low. Since the vessel B is absent inside the angle of view, no point is given to the item of "inside of angle of view". As described above, since the vessel B is present outside the imaging angle of view Z, the distance is large, and the moving speed is low, but the vessel B may be present on the scheduled course W. Thus, the total point is determined to be a high value of 3 points.

For the reef D, 1 point is given to the item of "distance" because a distance between the reef D and the moving body is large, and 0 points is given to the item of "moving speed" because the moving speed of the reef D is very low. Since the reef D is absent inside the angle of view, and is also absent on the scheduled course W, no point is given to these items.

As described above, since the reef D is present outside the imaging angle of view Z, the moving speed of the reef D is very low, and the reef D is absent on the scheduled course W, the total point is determined to be a low value of 1 point.

As described above, the priority determination unit 205 gives a point that is increased as the object has a higher possibility of approaching the moving body, to each of the objects based on at least the positional information on the detected objects, and determines the imaging priority based on the points given to each of the objects. The items illustrated in FIGS. 5 and 6 are examples of the indices for determining the imaging priority, the priority determination may be performed using other indices, and a calculation method of the points is not limited to an adding method and may be an optional calculation method.

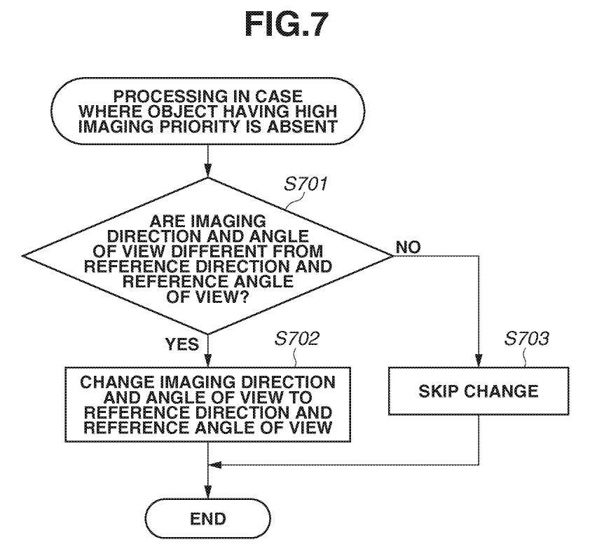

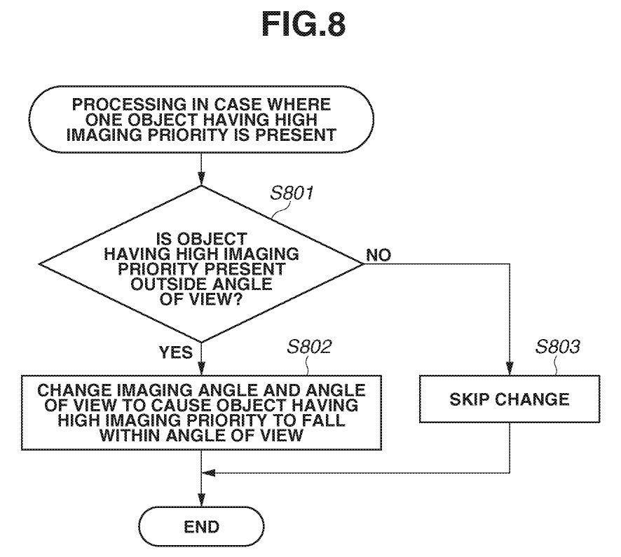

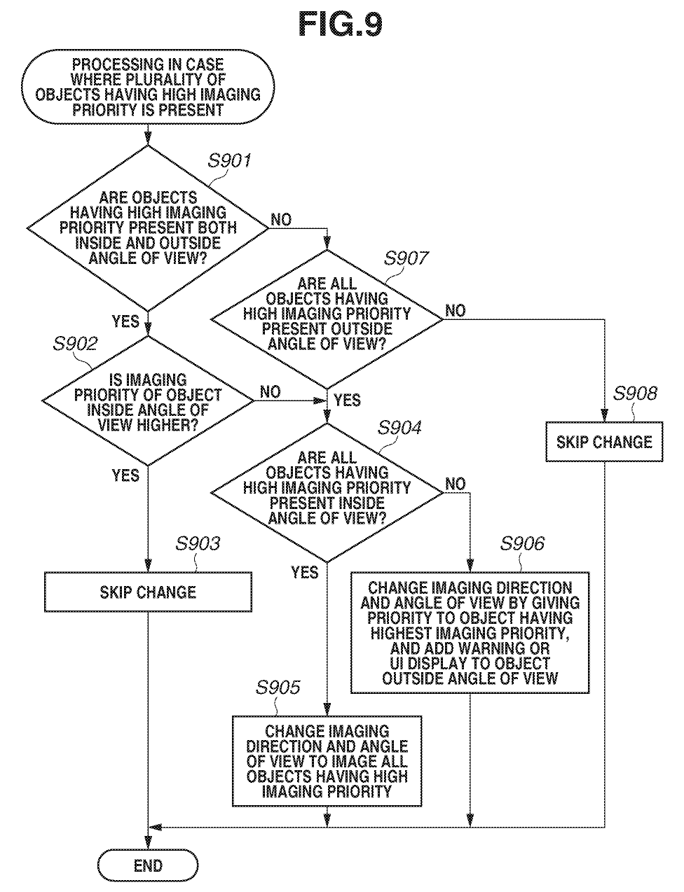

Returning to FIG. 3., in step S306 after step S305 described above, the priority determination unit 205 determines the number (N) of objects having high imaging priority, which is the number of objects having imaging priority exceeding, for example, a threshold that is optionally set in advance. In a case where the object having high imaging priority is absent and a determination result by the priority determination unit 205 is N = 0 (N = 0 in step S306), the processing by the imaging control apparatus 103 proceeds to step S307. Processing in step S307 is performed by the control unit 206. Details of the processing in step S307 are described below with reference to a flowchart illustrated in FIG. 7. In a case where the number of objects having high imaging priority is 1, and the determination result by the priority determination unit 205 is N = 1 (N = 1 in step S306), the processing by the imaging control apparatus 103 proceeds to step S308. Processing in step S308 is performed by the control unit 206. Details of the processing in step S308 are described below with reference to a flowchart illustrated in FIG. 8. In a case where the number of objects having high imaging priority is large, and in the case where the determination result by the priority determination unit 205 is N > 1 (N > 1 in step S306), the processing by the imaging control apparatus 103 proceeds to step S309. Processing in step S309 is performed by the control unit 206. Details of the processing in step S309 are described below with reference to a flowchart illustrated in FIG. 9.

FIG. 7 is a flowchart illustrating a detailed flow of the processing in step S307 performed by the control unit 206 in the case where an object having high imaging priority is absent, and in the case where the determination result by the priority determination unit 205 is N = 0.

In step S701, the control unit 206 determines whether the imaging angle of view in the imaging direction of the imaging apparatus 101 at the present moment is different from a reference angle of view in a previously set reference direction. The reference direction and the reference angle of view are a direction and an angle of view previously designated by a user, and the imaging apparatus 101 stores the PTZ setting information corresponding to the reference direction and the reference angle of view. In the present embodiment, it is assumed that the reference direction is set as a front direction of the moving body or the traveling direction of the moving body. In a case where the control unit 206 determines that the imaging direction and the angle of view of the imaging apparatus 101 at the present moment are not coincident with the reference direction and the reference angle of view (YES in step S701), the processing proceeds to step S702. In a case where the control unit 206 determines that the imaging direction and the angle of view of the imaging apparatus 101 at the present moment are coincident with the reference direction and the reference angle of view (NO in step S701), the processing proceeds to step S703.

In step S702, since objects having high imaging priority are absent, and the imaging direction and the angle of view are not coincident with the reference direction and the reference angle of view, the control unit 206 changes the imaging direction and the imaging angle of view of the imaging apparatus 101 to be coincident with the reference direction and the reference angle of view.

In step S703, since objects having high imaging priority are not absent, and the imaging direction and the imaging angle of view are coincident with the reference direction and the reference angle of view, the control unit 206 does not change the imaging direction and the angle of view of the imaging apparatus 101.

As described above, unless the object having high imaging priority is present, the control unit 206 controls the imaging direction and the angle of view of the imaging apparatus 101 to give priority to imaging at the reference angle of view in the reference direction described above.

FIG. 8 is a flowchart illustrating a detailed flow of the processing in step S308 in FIG. 3 performed by the control unit 206 in the case where one object having high imaging priority is present, and the determination result by the priority determination unit 205 is N = 1.

In step S801, the control unit 206 determines whether an object having high imaging priority is present outside the imaging angle of view in the imaging direction of the imaging apparatus 101 at the present moment. In a case where the control unit 206 determines that the object having high imaging priority is present outside the imaging angle of view (YES in step S801), the processing proceeds to step S802. In a case where the control unit 206 determines that an object having high imaging priority is absent outside the imaging angle of view (NO in step S801), the processing proceeds to step S803.

In step S803, since the object having high imaging priority is already present inside the imaging angle of view, the control unit 206 does not change the imaging direction and the imaging angle of view of the imaging apparatus 101.

In step S802, the control unit 206 changes the imaging direction and the angle of view of the imaging apparatus 101 such that the object having high imaging priority falls within the imaging angle of view (e.g., is positioned at the center of imaging angle of view). In step S802, only the imaging direction may be changed such that the object having high imaging priority falls within the imaging angle of view. In a case where the object having high imaging priority can be caused to fall within the imaging angle of view only by changing the angle of view, only the angle of view may be changed. It is also unnecessary to position the object having high imaging priority at the center of the imaging angle of view, and it is sufficient for the object having high imaging priority to fall within the angle of view.

FIG. 10 is a diagram illustrating an example in a case where the control unit 206 changes the imaging direction and the angle of view of the imaging apparatus 101 mounted on the moving body (vessel). In this example, it is assumed that the traveling direction (scheduled course W) of the moving body is previously designated as the reference direction by the user. FIG. 10 also illustrates an example in a case where only the imaging direction is changed and the imaging angle of view is not changed.

FIG. 10 illustrates an imaging angle of view Q of the imaging apparatus 101 after the imaging direction of the imaging apparatus 101 is changed from a direction of the scheduled course W (reference direction) illustrated in FIG. 6 to a direction of the object (vessel A) having high imaging priority, present outside the reference angle of view in the reference direction, by pan control. In the example illustrated in FIG. 10, in a case where only one vessel A having high imaging priority has been detected outside the reference angle of view, the control unit 206 changes the imaging direction such that the angle of view is changed from the reference angle of view P in the traveling direction of the moving body to the imaging angle of view Q, by pan control in a pan direction indicated by an arrow 1001 in FIG. 10. In other words, the control unit 206 changes the imaging direction of the imaging apparatus 101 such that the object (vessel A) having high imaging priority is positioned at the center of the imaging angle of view.

A radar screen R illustrated in FIG. 10 illustrates a screen example in which the positional information acquired from the object information by the sensing device 102, and the imaging direction and the angle of view of the imaging apparatus 101 are displayed on a display screen of a radar (not illustrated) provided in the vessel as the moving body. In the radar screen R, the angle of view P indicates the reference angle of view in the traveling direction (reference direction) of the moving body, and the angle of view Q indicates the imaging angle of view changed by pan control. For example, in a case where the image captured by the imaging apparatus 101 at the imaging angle of view Q is displayed on the monitor (display apparatus 105), the radar screen R can be displayed superimposed on the captured image. FIG. 10 also illustrates a display image thereof.

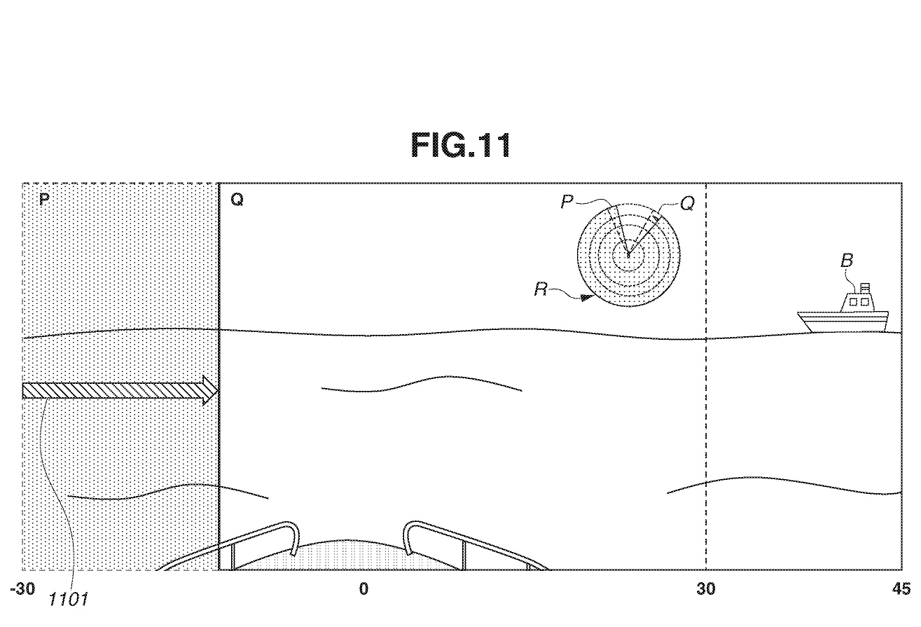

FIG. 11 is a diagram illustrating another example in which the control unit 206 changes the imaging direction and the angle of view of the imaging apparatus 101 mounted on the moving body (vessel). As with the example illustrated in FIG. 10, FIG. 11 also illustrates an example in the case where the traveling direction (scheduled course W) of the moving body is designated as the reference direction, only the imaging direction is changed, and the imaging angle of view is not changed. In the example illustrated in FIG. 11, it is assumed that the imaging direction of the imaging apparatus 101 is the same direction as the direction of the scheduled course W (reference direction) illustrated in FIG. 6.

FIG. 11 illustrates an example in a case where the vessel B present outside the reference angle of view in the reference direction is travelling in the traveling direction of the moving body, namely, in a direction toward a sea area at which the moving body may arrive, and therefore, the vessel B has high imaging priority. In this case, the control unit 206 changes the imaging direction of the imaging apparatus 101 such that the vessel B having high imaging priority, which has been present outside the reference angle of view, falls within a corner of the imaging angle of view, and the traveling direction of the moving body and the vessel B fall within the imaging angle of view. In other words, in the example illustrated in FIG. 11, the control unit 206 changes the imaging direction such that the traveling direction of the moving body and the vessel B fall within the same imaging angle of view, by pan control in a direction indicated by an arrow 1101 in FIG. 11.

Even in the example illustrated in FIG. 11, the radar screen R similar to the above description may be displayed on the screen of the display apparatus 105 by being superimposed on the captured image acquired by the imaging apparatus 101 at the imaging angle of view Q.

FIG. 9 is a flowchart illustrating a detailed flow of the processing in step S309 in FIG. 3 performed by the control unit 206 in the case where a plurality of objects having high imaging priority is present, and in the case where the determination result by the priority determination unit 205 is N > 1.

In the case where a plurality of objects having high imaging priority is present, in step S901, the control unit 206 determines whether the objects having high imaging priority are present both inside and outside the imaging angle of view of the imaging apparatus 101. In a case where the control unit 206 determines that the objects having high imaging priority are present both inside and outside the imaging angle of view (YES in step S901), the processing proceeds to step S902. In a case where the control unit 206 determines that the objects having high imaging priority are present only inside or outside the imaging angle of view (NO in step S901), the processing proceeds to step S907.

In step S902, the control unit 206 compares the imaging priority of the object inside the imaging angle of view and the imaging priority of the object outside the imaging angle of view. In a case where the imaging priority of the object inside the imaging angle of view is higher (YES in step S902), the processing proceeds to step S903. In a case where the imaging priority of the object outside the imaging angle of view is higher (NO in step S902), the processing proceeds to step S904.

In step S903, the object having higher imaging priority is present inside the imaging angle of view, and thus the control unit 206 does not change the imaging direction and the angle of view of the imaging apparatus 101.

In step S907, the control unit 206 determines whether all the objects having high imaging priority are present outside the imaging angle of view or are present inside the imaging angle of view. In a case where the control unit 206 determines that all the objects having high imaging priority are present outside the imaging angle of view (YES in step S907), the processing proceeds to step S904. In a case where the control unit 206 determines that all the objects having high imaging priority are present inside the imaging angle of view (NO in step S907), the processing proceeds to step S908.

In step S908, all the objects having high imaging priority are present inside the same imaging angle of view, and thus the control unit 206 does not change the imaging direction and the angle of view.

In step S904, the control unit 206 determines whether all the objects having high imaging priority present outside the imaging angle of view can be caused to fall within the same imaging angle of view of the imaging apparatus 101. In a case where the control unit 206 determines that all the objects having high imaging priority can be caused to fall within the same imaging angle of view (YES in step S904), the processing proceeds to step S905. In a case where any of the objects having high imaging priority cannot be caused to fall within the same imaging angle of view (NO in step S904), the processing proceeds to step S906.

In step S905, the control unit 206 changes the imaging direction and the angle of view of the imaging apparatus 101 such that all the objects having high imaging priority fall within the imaging angle of view. Note that in a case where all the objects having high imaging priority can be caused to fall within the angle of view in step S905, only the imaging direction may be changed to cause the objects having high imaging priority to fall within the imaging angle of view. In a case where all the objects having high imaging priority can be caused to fall within the imaging angle of view only by changing the angle of view, only the angle of view may be changed.

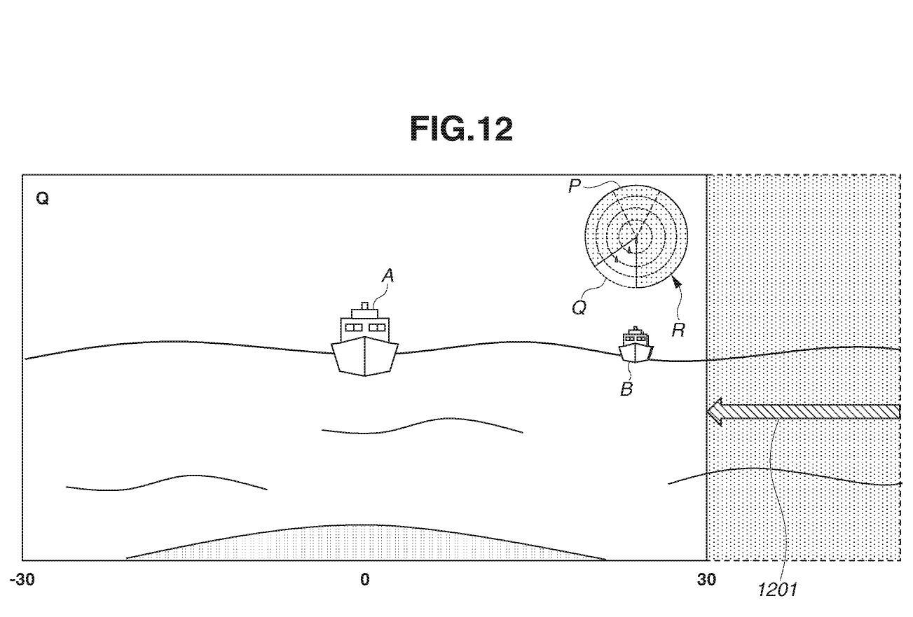

FIG. 12 is a diagram illustrating an example in which, in a case where objects (vessel A and vessel B) having high imaging priority are present and all the objects having high imaging priority can be caused to fall within the imaging angle of view, the imaging direction is controlled such that the objects fall within the same imaging angle of view. As with the above-described example, FIG. 12 illustrates an example in which only the imaging direction is changed and the imaging angle of view is not changed, and also illustrates the radar screen R similar to the above description. In a case where both the vessel A and the vessel B can be caused to fall within the same imaging angle of view, the control unit 206 performs pan control in a pan direction indicated by an arrow 1201 in FIG. 12, to change the imaging direction such that the imaging apparatus 101 has the imaging angle of view Q.

In step S906, the control unit 206 changes the imaging direction and the angle of view by giving priority to the object having the highest imaging priority.

In addition, for example, the control unit 206 may add a warning or UI display 1410 for notifying the user of presence of the object having high imaging priority present outside the angle of view to the radar screen R on the screen of the display apparatus 105.

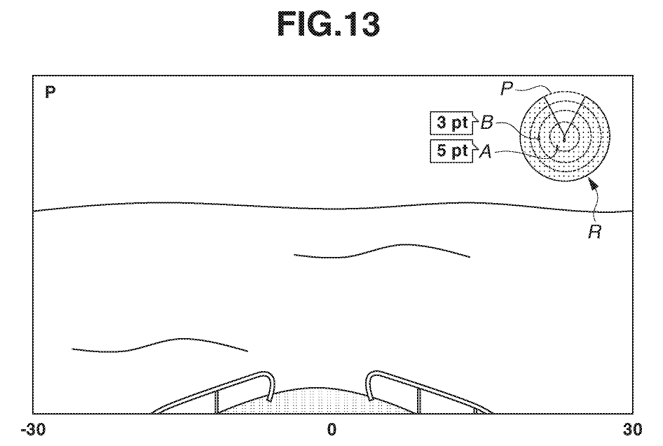

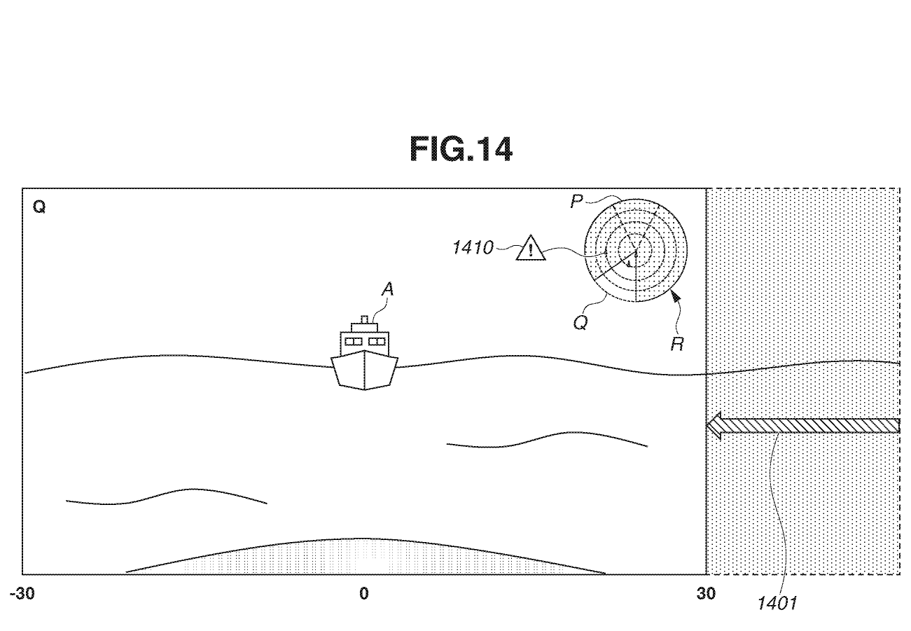

FIGS. 13 and 14 are diagrams each illustrating a scene example in which a plurality of objects having high imaging priority is present outside the imaging angle of view. As with the above-described example, FIGS. 1314 each illustrate an example in which only the imaging direction is changed and the imaging angle of view is not changed, and also illustrate the radar screen R similar to the above description. FIG. 13 illustrates a situation where the vessel A and the vessel B are present outside the imaging angle of view, and do not fall within the reference imaging angle of view P. However, a total point of the imaging priority of the vessel A is 5 points because the distance of the vessel A from the moving body is small, the moving speed of the vessel A is high, and the vessel A has a high possibility of approaching the moving body. A total point of the imaging priority of the vessel B is 3 points because the distance of the vessel B from the moving body is large, and the moving speed of the vessel B is low. In a case where the vessel A and the vessel B, both of which have high imaging priority, are present outside the imaging angle of view as in the example illustrated in FIG. 13, the control unit 206 changes the imaging direction and the angle of view by giving priority to the vessel A having the highest total point as illustrated in FIG. 14. In other words, the control unit 206 changes the imaging direction such that the imaging apparatus 101 has the imaging angle of view Q by performing pan control in a pan direction indicated by an arrow 1401 in FIG. 14.

The processing in and after step S306 in the flowchart illustrated in FIG. 3 may be performed on all captured images input from the imaging apparatus 101 in a time-series order. The processing may also be performed in a case where the imaging priority is changed or in a case where the sensing device 102 detects a new object.

As described above, according to the first embodiment, it is possible, based on the result of the determination whether the object is inside or outside the imaging angle of view and the imaging priority, to grasp the surrounding situation and to monitor the objects around the moving body without impairing controllability of the moving body by changing the imaging direction and the angle of view.

In the above-described embodiment, the imaging apparatus that can perform PTZ driving is assumed, and change of the imaging direction and the angle of view using pan/tilt/zoom is described as an example. However, the configuration is not limited to this example. For example, an omnidirectional captured image may be acquired by an omnidirectional camera, and a partial image may be cut out from the omnidirectional captured image based on a result of inside/outside determination about a reference angle of view and the imaging priority.

In the above-described embodiment, the case where the imaging system is mounted on a vessel is assumed as an example. However, the configuration is not limited thereto. The imaging system can be applied to all moving bodies, like an underwater moving body such as a submersible vessel, a ground moving body such as an automobile, and an aeronautical moving body such as a drone. The moving body may be operated by a person actually riding on the moving body, or may be remotely operated.

In the above-described embodiment, the example in which the in-angle-of-view determination unit 203 performs the in-angle-of-view determination based on the positional information on the object acquired from the position detection unit 204, the reference direction, and the reference angle of view is described. However, the configuration is not limited thereto. The in-angle-of-view determination unit 203 may perform the in-angle-of-view determination based on the positional information on the object, a current imaging direction, and a current angle of view. In a case where the in-angle-of-view determination is performed based on the reference direction and the reference angle of view, the in-angle-of-view determination can be performed by giving priority to the traveling direction of the moving body, the angle of view designated by the user, and the like. In a case where the in-angle-of-view determination is performed using the current imaging direction and the current angle of view, the in-angle-of-view determination can be performed by giving priority to an angle of view capturing an object present around the current imaging angle of view.

### Second Embodiment

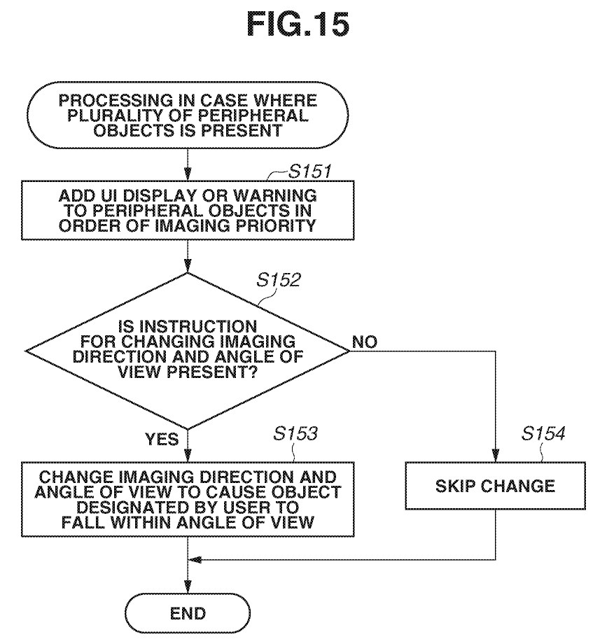

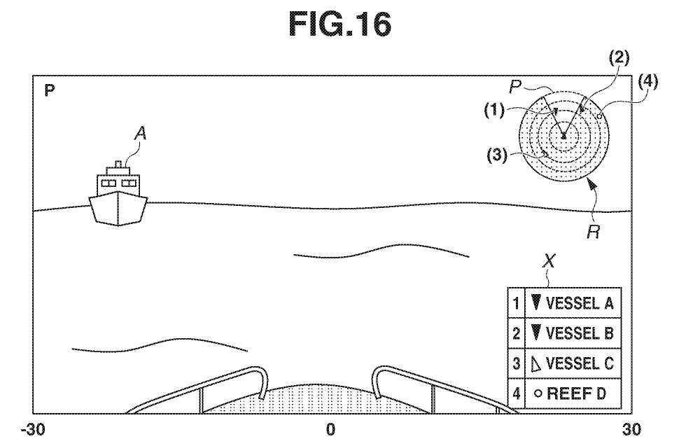

As a second embodiment, a configuration is described in which information about peripheral objects is displayed to the user based on the imaging priority, and the imaging direction and the angle of view are changed for an object designated by the user. The components, the processing steps, and the like that are the same as in the first embodiment are denoted by the same reference numerals, and description thereof is omitted. For example, in the flowchart illustrated in FIG. 3, the processing steps in the second embodiment from step S301 to step S305 are similar to the processing steps in the first embodiment, and therefore, description of these processing steps is omitted. Description in a case where an object is absent around the moving body is also omitted because it is unnecessary to change the imaging direction and the angle of view. With respect to the second embodiment, a case where one or more objects are present around the moving body is described as an example with reference to a flowchart illustrated in FIG. 15 and an example illustrated in FIG. 16. FIG. 16 is a diagram illustrated in a manner similar to FIGS. 10 to 14 and the like described above.

In FIG. 15, in step S151, the control unit 206 displays a peripheral object list X as illustrated in FIG. 16, on the screen of the display apparatus 105, and displays icons and object names of the objects on the radar screen R in the peripheral object list X in order of points of the imaging priority of the objects. At this time, the radar screen R and the peripheral object list X are displayed to enable distinction of an object having high imaging priority (object having imaging priority exceeding threshold) and an object having low imaging priority (object having imaging priority less than or equal to threshold). In a case of the example illustrated in FIG. 16, vessels A to C are displayed as icons each having a triangular shape that schematically illustrates a shape of a vessel and can represent a traveling direction of the vessel, and a reef D is displayed as an icon having a round shape that represents a non-moving object. An icon representing the object having high imaging priority (icons of vessel A and vessel B) is displayed with solid black, whereas an icon representing the object having low imaging priority (icons of vessel C and reef D) is displayed with solid white.

In a manner similar to the above description, the control unit 206 may add a warning or UI display for notifying the user of presence of the object having high imaging priority present outside the angle of view to the radar screen R on the screen of the display apparatus 105.

In step S152, the control unit 206 determines whether an instruction for changing the imaging direction, the angle of view, and the like has been issued from the user via the input apparatus 104. In a case where the control unit 206 determines that the change instruction has been issued (YES in step S152), the processing proceeds to step S153. In a case where the control unit 206 determines that the change instruction has not been issued (NO in step S152), the processing proceeds to step S154.

In step S153, the control unit 206 changes the imaging direction and the angle of view of the imaging apparatus 101 such that the object designated by the user falls within the imaging angle of view. In step S153, the control unit 206 may change only the imaging direction such that the object designated by the user falls within the imaging angle of view.

In a case where the object designated by the user can be caused to fall within the imaging angle of view by changing only the angle of view, only the angle of view may be changed. It is unnecessary to position the object designated by the user at a center of the imaging angle of view, and it is sufficient for the object designated by the user to fall within the angle of view.

In step S154, since the instruction from the user is absent, the control unit 206 does not change the imaging direction and the angle of view of the imaging apparatus 101.

Even after the control unit 206 performs the processing in step S153 or step S154, the control unit 206 continues the UI display and the warning about the peripheral object.

A UI for returning the imaging direction and the angle of view to the reference direction and the reference angle of view may be prepared. In a case where a change instruction has been issued from the user during processing in the flowchart illustrated in FIG. 15, the control unit 206 may change the imaging direction and the angle of view.

As described above, in the second embodiment, the peripheral object information is displayed to the user based on the imaging priority, and the imaging direction and the angle of view are changed such that the object designated by the user falls within the imaging angle of view of the imaging apparatus. According to the second embodiment, it is thereby possible to present the object having high imaging priority, and to adjust the imaging direction and the angle of view to the object to be monitored by the user.

In the second embodiment, training may be performed using information on the object designated to be monitored by the user, and an index for determining the imaging priority may be added or point allocation may be changed. In this case, it is possible to provide an apparatus more suitable for the user.

The present disclosure can be realized by supplying a program realizing one or more functions of the above-described embodiments to a system or an apparatus via a network or a storage medium, and causing one or more processors in a computer of the system or the apparatus to read out and execute the program. The present disclosure can be realized by a circuit (e.g., application specific integrated circuit (ASIC)) realizing one or more functions.

The above-described embodiments are specific examples for implementing the present disclosure, and the technical scope of the present disclosure should not be interpreted limitedly by these embodiments. In other words, the present disclosure can be implemented in various forms without departing from the technical idea or main features of the present disclosure.

According to the present disclosure, it is possible to maintain controllability of the moving body while monitoring a peripheral object requiring monitoring.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-077995, filed May 8, 2025, which is hereby incorporated by reference herein in its entirety.

What is claimed is:

1. An imaging control apparatus controlling an imaging apparatus, comprising:
at least one memory storing a program; and
at least one processor, that when executing the program, causes the imaging control apparatus to:
determine whether a position of an object present around a moving body is within an angle of view of the imaging apparatus;
determine imaging priority of the object based on the position of the object; and
control at least one of an imaging direction of the imaging apparatus or the angle of view of the imaging apparatus based on the determined position of the object t and the determined imaging priority.

2. The imaging control apparatus according to claim 1, wherein the imaging apparatus is mounted on the moving body and images surroundings of the moving body.

3. The imaging control apparatus according to claim 1, wherein the imaging direction of the imaging apparatus and the angle of view of the imaging apparatus are controlled based on the determined position of the object and the determined imaging priority.

4. The imaging control apparatus according to claim 1, wherein the angle of view of the imaging apparatus when the position of the object is determined is an imaging angle of view in an imaging direction in which the imaging apparatus performs imaging or a reference angle of view in a previously set reference direction.

5. The imaging control apparatus according to claim 1, wherein the imaging direction of the imaging apparatus is controlled to cause an object having the imaging priority exceeding a threshold to fall within the angle of view of the imaging apparatus.

6. The imaging control apparatus according to claim 1, wherein, in a case where an object having the imaging priority exceeding a threshold is absent, the imaging direction of the imaging apparatus is to a previously set reference direction.

7. The imaging control apparatus according to claim 1, wherein, in a case where only one object having the imaging priority exceeding a threshold is present inside the angle of view of the imaging apparatus, the imaging direction of the imaging apparatus is not changed.

8. The imaging control apparatus according to claim 1, wherein, in a case where only one object having the imaging priority exceeding a threshold is present outside the angle of view of the imaging apparatus, the imaging direction of the imaging apparatus is controlled to cause the object having the imaging priority exceeding the threshold to fall within the angle of view of the imaging apparatus.

9. The imaging control apparatus according to claim 1, wherein, in a case where all of a plurality of objects having the imaging priority exceeding a threshold are present inside the angle of view of the imaging apparatus, the imaging direction of the imaging apparatus is not changed.

10. The imaging control apparatus according to claim 1, wherein, in a case where all of a plurality of objects having the imaging priority exceeding a threshold are present outside the angle of view of the imaging apparatus, the imaging direction of the imaging apparatus is controlled to cause all of the plurality of objects to fall within the angle of view of the imaging apparatus.

11. The imaging control apparatus according to claim 1, wherein, in a case where a plurality of objects having the imaging priority exceeding a threshold is present both inside and outside the angle of view of the imaging apparatus and the imaging priority of the objects inside the angle of view is higher than the imaging priority of the objects outside the angle of view, the imaging direction of the imaging apparatus is not changed.

12. The imaging control apparatus according to claim 1, wherein, in a case where a plurality of objects having the imaging priority exceeding a threshold is present both inside and outside the angle of view of the imaging apparatus and the imaging priority of the objects outside the angle of view is higher than the imaging priority of the objects inside the angle of view, the imaging direction of the imaging apparatus is controlled to cause the object outside the angle of view to fall within the angle of view of the imaging apparatus.

13. The imaging control apparatus according to claim 1, wherein, in a case where a plurality of objects having the imaging priority exceeding a threshold is present both inside and outside the angle of view of the imaging apparatus and the angle of view of the imaging apparatus is wider than an angle of view including all the objects having the imaging priority exceeding the threshold, the imaging direction of the imaging apparatus is controlled to cause all the objects having the imaging priority exceeding the threshold to fall within the angle of view of the imaging apparatus.

14. The imaging control apparatus according to claim 1, wherein, in a case where a plurality of objects having the imaging priority exceeding a threshold is present both inside and outside the angle of view of the imaging apparatus and the angle of view of the imaging apparatus is wider than a range based on at least a part of a reference angle of view in a previously set reference direction or positions of the plurality of objects having the imaging priority exceeding the threshold, the imaging direction of the imaging apparatus is controlled to cause at least a part of the reference angle of view or the plurality of objects having the imaging priority exceeding the threshold to fall within the angle of view of the imaging apparatus.

15. The imaging control apparatus according to claim 1, wherein, in a case where a plurality of objects having the imaging priority exceeding a threshold is present both inside and outside the angle of view of the imaging apparatus, notification is provided of a presence of the objects having the imaging priority exceeding the threshold outside the angle of view.

16. The imaging control apparatus according to claim 1, wherein determining the imaging priority is based on at least one of a distance between the moving body and the object, a speed of the object, a relative speed between the moving body and the object, a scheduled course of the moving body, or a traveling direction of the object.

17. The imaging control apparatus according to claim 1, wherein the position of the object present around the moving body is detected via a sensing device.

18. The imaging control apparatus according to claim 17, wherein the sensing device includes at least one of an acceleration sensor, a gyroscope, a radar, an automatic vessel identification apparatus, a sonar, or a distance sensor.

19. A method performed by an imaging control apparatus controlling an imaging apparatus, the method comprising:
determining whether a position of an object present around a moving body is within an angle of view of the imaging apparatus;
determining imaging priority of the object based on the position of the object; and
controlling at least one of an imaging direction of the imaging apparatus or an angle of view of the imaging apparatus based on the determined position of the object and the determined imaging priority.

20. A non-transitory computer-readable storage medium that stores a program for causing a computer to execute a method for controlling an imaging apparatus, the method comprising:
determining whether a position of an object present around a moving body is within an angle of view of the imaging apparatus;
determining imaging priority of the object based on the position of the object; and
controlling at least one of an imaging direction of the imaging apparatus or an angle of view of the imaging apparatus based on the determined position of the object and the determined imaging priority.
